(19) United States
(12) Patent Application Publication
(10) Pub. No.: US 2025/0345874 A1
(43) Pub. Date: Nov. 13, 2025

(54) TOOL WITH SUPPORTING FUNCTION

(71) Applicant: ROBURN COMPANY LTD., New Taipei City (TW)

(72) Inventor: Chin-Lin TSAI, New Taipei City (TW)

(21) Appl. No.: 18/910,883

(22) Filed: Oct. 9, 2024

(30) Foreign Application Priority Data
May 10, 2024 (TW) 113204797

(51) Int. Cl. B23K 3/02; B23K 3/08

(52) U.S. Cl. CPC B23K 3/022; B23K 3/08

(57) ABSTRACT

A tool with a supporting function includes a main body and a support; an accommodation space having a front seat and a rear seat disposed at two ends thereof and allowing the support to be accommodated is formed on the main body, a push bottom is sheathed with the rear seat to be operated to slide on the rear seat between a first position and a second position, a locking mechanism for locking or unlocking the support is disposed between the support and one end of the support, a pivotal connection mechanism is disposed between a pair of support arms at another end of the support and the front seat, the support can be outwardly rotated from the accommodation space with the pivotal connection mechanism served as a pivot for supporting the tool, or inwardly rotated to be placed in the accommodation space.

### BACKGROUND OF THE INVENTION

### Field of the Invention

The present invention relates to a tool, especially to a tool with a supporting function.

### Description of the Related Art

Fire is a must have element in our lives. Fire can be used for cooking food and providing lights, and the fire can also be used for combustion operations such as forging, soldering and welding. Take a gas combustor, such as a refillable lighter or a portable gas stove, as an example, an object can be ignited or food can be cooked. As such, the gas combustor still plays an important role in our lives which cannot be easily replaced.

A heating tool, for example a gas soldering iron or an electric soldering iron, is a tool having a soldering iron tip disposed at a front end thereof to generate heat for melting a soldering material, a user can use the heat generated by the soldering iron tool to perform a soldering operation, thus the temperature of the soldering iron tip at the front end of the soldering iron tool is very high. As such, when the soldering iron tool is desired to be pre-heated, temporally stopped or the soldering operation is finished, the soldering iron tool is required to be placed on a rack, so that peripheral objects or a table is prevented from being damaged due to the soldering iron tool rolling down, and the user is protected from being hurt due to accidentally touching the soldering iron tool. Taiwan Pat. No.1660807 (equivalent to U.S. Pat. No.10,486,254B1) has disclosed a tool having switch with support function. The tool includes a main body, and a switch. The switch capable of sliding between an opened position and a closed position relative to the main body is disposed at a radial outer periphery of the main body, wherein one side of the switch opposite to the main body is disposed with a support part with a supporting function.

As viewed from figures disclosed in the cited patent as references to provide a stable supporting effect, the bottom edge of the switch is wider than the top edge thereof to form a curved trapezoidal shape. However the support part has the disadvantage of being a fixed protruding part, which is not a compact structure. Besides the appearance of the curved trapezoidal shape shall be improved to provide a better visual effect.

Accordingly, the disadvantages existed in the cited patent shall be improved by the skilled people in the art.

### SUMMARY OF THE INVENTION

One primary objective of the present invention is to provide a tool with a supporting function, in which a support is able to be outwardly rotated to provide a supporting when the tool is in a non-operating state, for example being pre-heated, temporally stopped or the operation is finished, and the support is able to be stored after the operation is finished for providing a storing function, thus an advantage of being convenient in operation is provided.

Another objective of the present invention is to provide a tool with a supporting function, in which a magnetic attraction structure is additionally disposed on the support, so that when the tool is not in the operating state and the support is yet to be outwardly rotated, the tool can be directly attached to the magnetic conduction object, for example an iron-containing object, for being fastened. As such, the applicable field of the tool can be effectively expanded.

For achieving said objectives, one technical solution provided by the present invention is to provide a tool with a supporting function, which includes a main body and a support. An accommodation space allowing the support to be accommodated is concavely formed on a bottom surface of the main body, two ends of the accommodation space are disposed with a front seat and a rear seat, a push bottom is sheathed with the rear seat, thus the push button is operated to slide on the rear seat between a first position and a second position, wherein a locking mechanism used for locking or unlocking the support is disposed between the push button and one end of the support, a pivotal connection mechanism is disposed between a pair of support arms at another end of the support and the front seat, and the support is outwardly rotated from the accommodation space with the pivotal connection mechanism being served as a pivot for supporting the tool, and the support is inwardly rotated to be stored in the accommodation space.

According to one embodiment of the present invention, the push button is radially protruded with a pair of tabs, the pair of the tabs are sheathed with a pair of slide slots correspondingly formed on the rear seat, so that the push bottom is operated to axially slide on the rear seat between the first position and the second position.

According to one embodiment of the present invention, the pivotal connection mechanism includes a pair of pivotal shafts radially protruded from the front seat, and the pair of support arms are disposed with a pair of shaft holes pivotally connected to the pair of pivotal shafts.

According to one embodiment of the present invention, each of the shaft holes is formed as a C-shaped clip hole.

According to one embodiment of the present invention, a positioning mechanism is formed at a connecting surface of a periphery of a corresponding pivotal shaft, the positioning mechanism includes a positioning tenon arranged at one side of each of the shaft holes, and a positioning slot arranged at one side of each of the pivotal shafts, wherein, each of the positioning tenons is displaced with a rotating movement of the pair of the support arms to be buckled with a corresponding positioning slot form a positioned status.

According to one embodiment of the present invention, the locking mechanism includes a convex sheet arranged at a front end of the push button, and a tongue sheet abutting against the convex sheet and arranged at a rear end of the support; wherein adjacent surfaces of the convex sheet and the tongue sheet are respectively and correspondingly formed with a buckle tenon and a buckle slot capable of being mutually buckled or released, when the buckle tenon is buckled with the buckle slot, the push button locks the support; when the buckle tenon is released from the buckle slot, the push button unlocks the support.

According to one embodiment of the present invention, a penetrated hole is radially formed on the support, a pair of reverse hooks are disposed at at least one pair of opposite sides of the penetrated hole; the support further includes a magnetic attraction structure, the magnetic attraction structure includes a magnetic member defined as a strong magnet or a permanent magnet, and the magnetic member is buckled with the buckle hooks.

According to one embodiment of the present invention, the magnetic attraction structure further includes an iron-containing protection cover least capable of covering and attracting the magnetic member, a circumference at a top end of the iron-containing protection cover has at least one pair of outwardly-bent abutting sheets, the at least one pair of the outwardly-bent abutting sheets abut against a circumference of an inner wall of the penetrated hole, so that the magnetic member and the iron-containing protection cover are prevented being from outwardly released from the penetrated hole.

To make it easier for our examiner to understand the objective of the invention, its structure, innovative features, and performance, we use preferred embodiments together with the accompanying drawings for the detailed description of the invention.

### BRIEF DESCRIPTION OF THE DRAWINGS

FIG. 1 is a perspective exploded view showing the tool and the support according to the present invention;

FIG. 2 is another perspective exploded view showing the tool according to the present invention;

FIG. 3 is a perspective view showing the assembly of the tool and the support according to the present invention;

FIG. 4 is a cross sectional view taken along an A-A dashed line of FIG. 3 to show a combining status of the support and the magnetic attraction structure;

FIG. 5 is a cross sectional view taken along a B-B dashed line of FIG. 3 to show the tool being in a locking and storing status;

FIG. 6 is a cross sectional view the tool being in an unlocking status according to the present invention;

FIG. 7 is a schematic view the support being outwardly rotated relative to the main body of the tool according to the present invention;

FIG. 8 is a schematic view the tool not being in an operating state and the support being outwardly rotated for being placed on the worktable according to the present invention; and

FIG. 9 is a schematic view the tool not being in an operating state and the magnetic attraction structure of support being attracted on a magnetic conduction object according to the present invention.

### DETAILED DESCRIPTION OF THE PREFERRED EMBODIMENTS

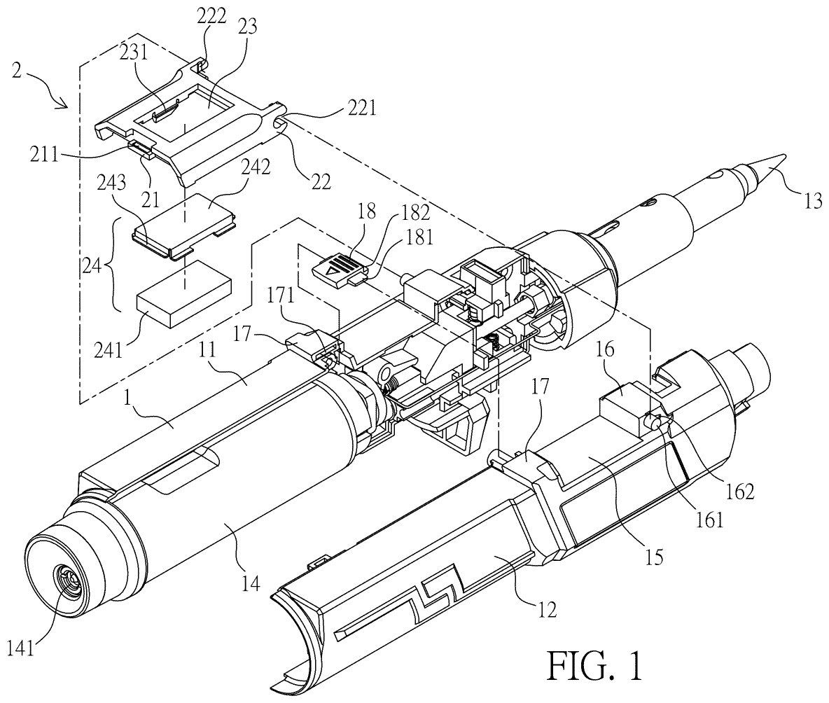

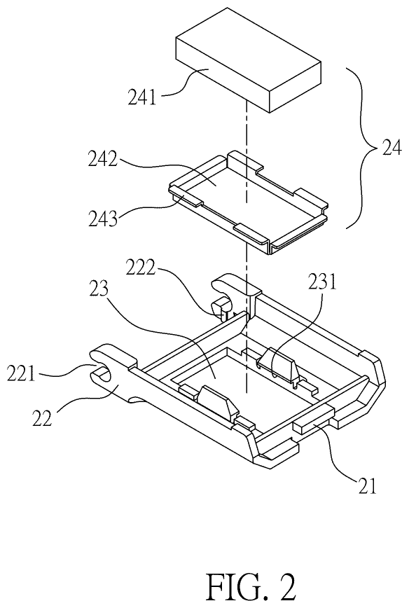

Please refer from FIG. 1 to FIG. 8, the present invention provides a tool, which includes a main body 1 and a support 2.

Please refer to FIG. 1, the main body 1 is formed with a manner of a left shell 11 and a right shell 12 being engaged, so that the tool is configured as a pencil-shaped member. In an actual operation, the tool is desired to be used as a gas combustion tool for example a gas soldering gun. Accordingly, one end of the gas soldering gun is disposed with a soldering iron tip 13, and another end thereof is disposed with a fuel storage tank 14. One free end of the fuel storage tank 14 is in communication with a filling nozzle 141, thus high-pressure liquid gas is able to be filled and stored in the fuel storage tank 14 via the filling nozzle 141, and an advantage of being convenient in operation is provided.

Technical characteristics of the main body 1 are provided as follows. An accommodation space 15 is concavely formed on a bottom surface of the main body 1. One end of the main body 1 arranged adjacent to the accommodation space 15 is disposed with a front seat 16. The front seat 16 is disposed with a pivotal connection mechanism, for example a pair of pivotal shafts 161 radially protruded; and another end of the main body 1 is disposed with a rear seat 17. The rear seat 17 is disposed with a push button 18 capable locking or unlocking the support 2. The push button 18 is radially protruded with a pair of tabs 181. The pair of the tabs 181 are sheathed with a pair of slide slots 171 correspondingly formed on the rear seat 17, so that the push bottom 18 can axially move on the rear seat 17. A locking mechanism is oppositely disposed at a front end of the push button 18 and a rear end of the support 2, thus the push button 18 can lock or the unlock the support 2.

According the one embodiment of the present invention, the locking mechanism includes a convex sheet 182 having a buckle tenon 183 arranged at a front end of the push button 18, and a tongue sheet 21 abutting against the convex sheet 182 and having a buckle slot 211 arranged at a rear end of the support 2. When the buckled tenon 183 is buckled with the buckle slot 211, the push button 18 locks the support 2; in other words, when the buckled tenon 183 is released from the buckle slot 211, the push button 18 unlocks the support 2.

According to another embodiment of the present invention, a buckle slot of the locking mechanism is disposed on the convex sheet 182, and a buckle tenon is disposed on the convex sheet 182, and the aforesaid locking or unlocking effect can also be achieved.

The support 2 is a plate member accommodated in the accommodation space 15. A pair of support arms 22 are axially protruded from the support 2 and arranged at locations corresponding to the pair of pivotal shafts 161 of the front seat 16. One free end of each of the support arms 22 is formed with a shaft hole 221 pivotally connected to one of the pivotal shafts 161. It is easy to be understood that the shaft hole 221 is a C-shaped clip hole according to the figures. As such, the pair of the support arms 22 and the shaft holes 221 thereof are defined as a portion of the pivotal connection mechanism.

For allowing a positioning effect to be formed between the support 2 and the main body 1 after the support 2 being outwardly rotated, a positioning mechanism is formed at a connecting surface of each of the shaft holes 221 and a periphery of the corresponding pivotal shaft 161. The positioning mechanism includes a positioning tenon 222 arranged at one side of each of the shaft holes 221, and a positioning slot 162 arranged at one side of each of the pivotal shafts 161. As such, each of the positioning tenons 222 can be displaced along rotations of the pair of the support arms 22 until being buckled with the corresponding positioning slot 162, so that the support 2 is outwardly rotated to a maximum angle, and the main body 1 is able to be placed on a worktable for a purpose of being supported.

For allowing the support 2 to be provided a magnetically attracting function in a flat state when being in a stored status, a penetrated hole 23 is radially formed on the support 2. As shown in figures, the penetrated hole 23 is formed in a rectangular shape. A pair of reverse hooks 231 are disposed at at least one pair of opposite sides of the penetrated hole 23. A magnetic attraction structure 24 includes a magnetic member 241, for example a strong magnet or a permanent magnet, buckled with the buckle hooks 231.

For avoiding a difficulty of a bottom part of the magnetic member 241 being processed to a stepped shape for abutting against and being tightened in the penetrated hole 23, thus the magnetic attraction structure 24 further includes an iron-containing protection cover 242 least capable of covering and attracting the magnetic member 241. Wherein, the appearance of the iron-containing protection cover 242 is matched with the appearance of the penetrated hole 23, a circumference at a top end of the iron-containing protection cover 242 has at least one pair of outwardly-bent abutting sheets 243. The at least one pair of the outwardly-bent abutting sheets 243 abut against a circumference of an inner wall of the penetrated hole 23, so that the magnetic member 241 and the iron-containing protection cover 242 are prevented being from outwardly released from the penetrated hole 23.

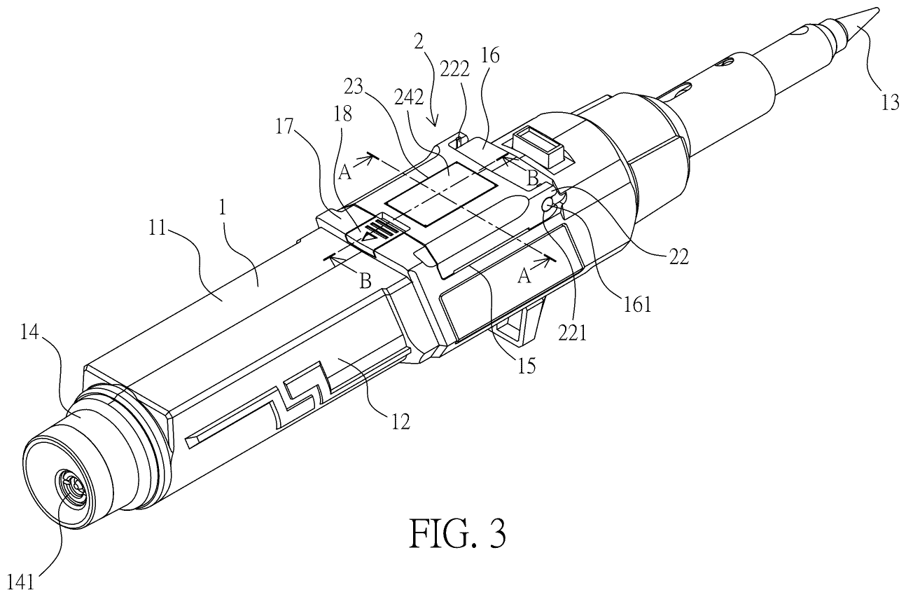

Please refer to FIG. 3, after a heating tool is assembled according to the aforesaid illustrations and figures, the support 2 has been accommodated in the accommodation spaced 15, at this moment the push button 18 is located at a first position and locks the support 2, in other words the buckle tenon 183 is buckled with the buckle slot 211, so that the support 2 is prevented from being outwardly rotated. As such, a user can operate the heating tool, such as the gas soldering iron, to perform a soldering operation.

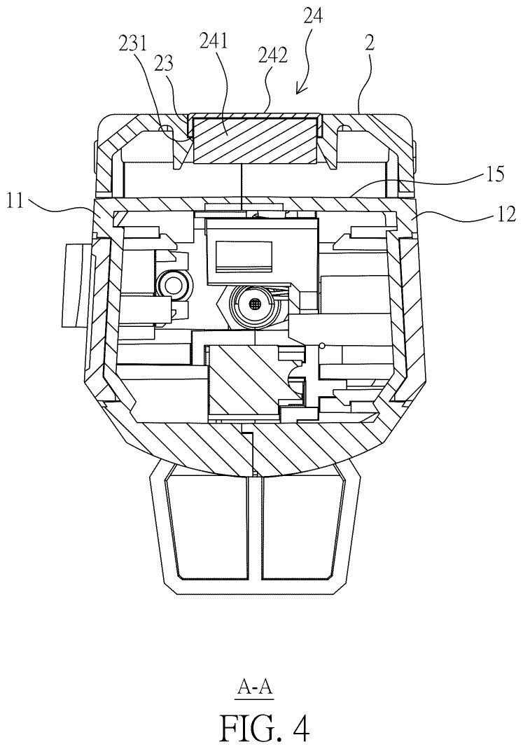

Please refer to FIG. 4, which is a cross sectional view taken along an A-A dashed line of FIG. 3 to show the pair of buckle hooks 231 of the support 2 are buckled at a bottom edge of the iron-containing protection cover 242 of the magnetic connection structure 24, the magnetic member 241 and the iron-containing protection cover 242 are both combined with the pair of the buckle hooks 231, and a bottom part of the iron-containing protection cover 242 is sheathed with the penetrated hole 23 to establish a flat status with an outer surface of the support 2.

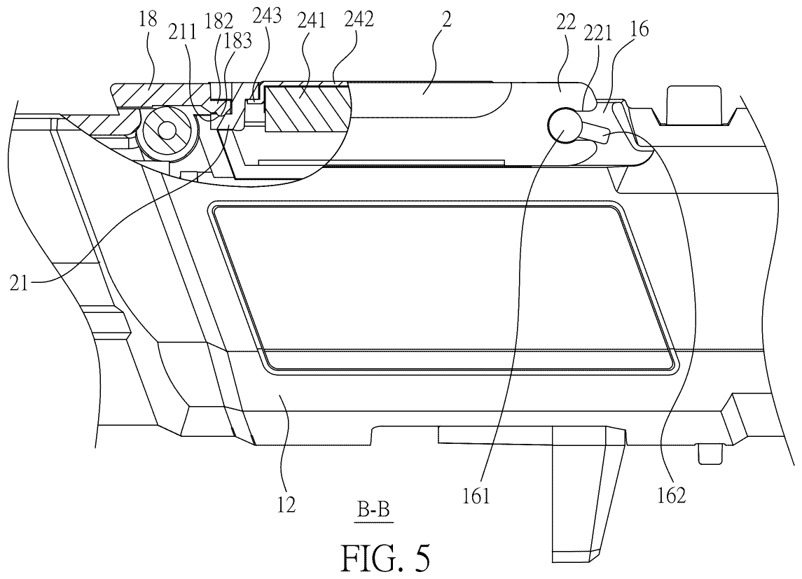

Please refer to FIG. 5, which is a cross sectional view taken along a B-B dashed line of FIG. 3. It is easy to be understood from the figure that the convex sheet 182 of the push button 18 abuts against the tongue sheet 21 of the support 2, and the buckle tenon 183 of the convex sheet 182 is buckled with the buckle slot 211 of the tongue sheet 21, thus the push button 18 locks the support 2 to form a locking and storing status.

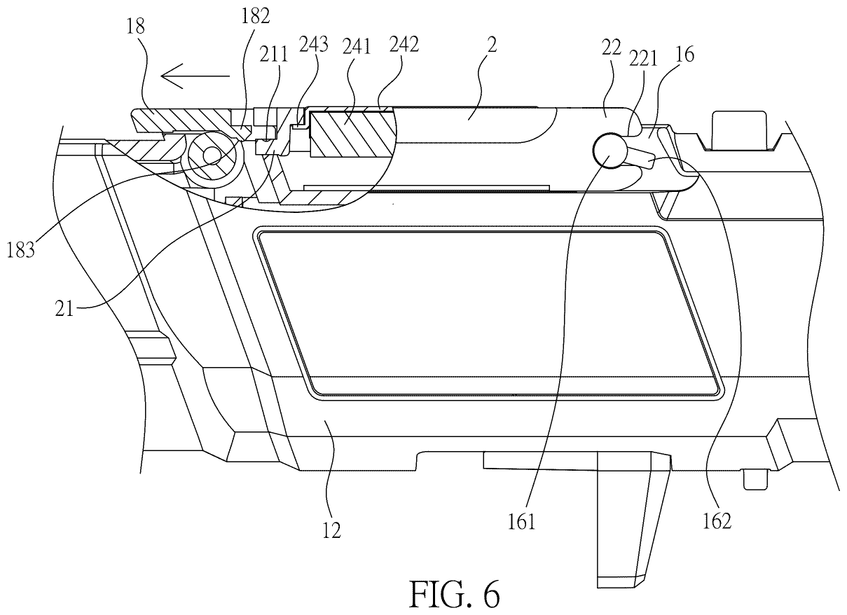

Please refer to FIG. 6, when the heating tool is desired to be pre-heated, temporally stopped or the heating operation is finished, the user only needs to backwardly push the push button 18 to a second position to make the buckle tenon 183 of the convex sheet 182 be released from the buckle slot 211 of the tongue sheet 21, the convex sheet 182 of the push button 18 is released from the tongue sheet 21 of the support 2 to form an unlocking status.

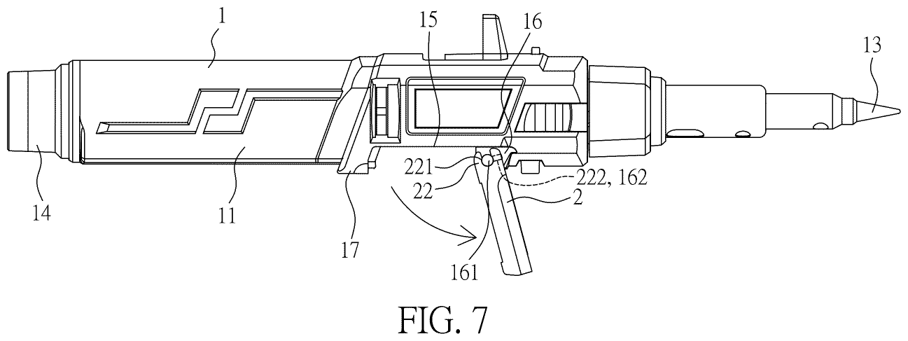

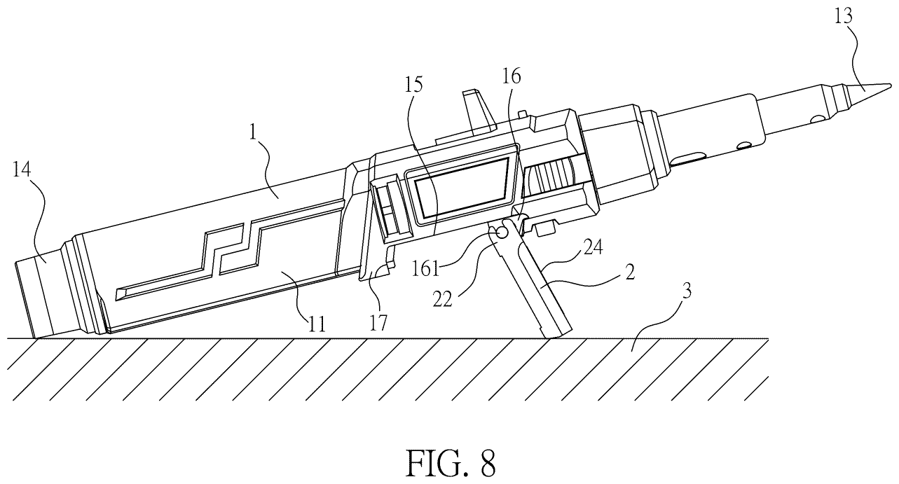

Please refer from FIG. 7 and FIG. 8, the user outwardly rotates the support 2, the pivotal shaft structure, for example the shaft holes 221 of the pair of support arms 22 are served as a pivot corresponding to each of the pivotal shafts 161, and rotated in a counterclockwise direction, the positioning mechanism, for example each of the positioning tenons 222, is able to be displaced along the rotations of the pair of the support arms 22 until being buckled with the corresponding positioning slot 162 to form a positioning effect, in other words the support 2 is outwardly rotated to the maximum angle. At this moment, the main body 1 can be placed on a worktable 3 for a purpose of being supported.

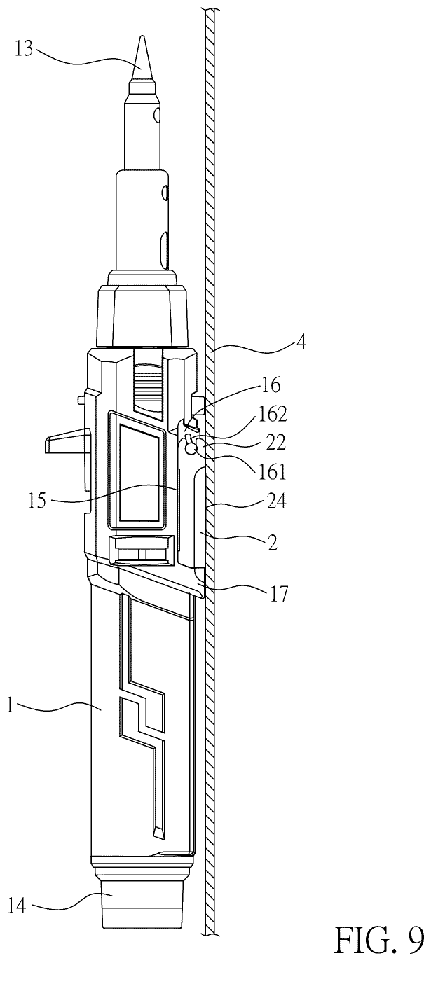

Please refer to FIG. 9, which shows the heating tool is not in a operating state, the magnetic attraction structure 24 of the support 2 can attract a magnetic conduction object 4, for example a metal vehicle frame. Especially, the magnetic attraction structure 24 can be freely detached from or installed on the support 2, thus an advantage of being convenient in operation is provided.

Based on what has been disclosed above, advantages achieved by the present invention are as follows. One end of the support is operated to slide between the first position and the second position through the locking mechanism of the push button for locking or unlocking the support. With the installation of the pivotal connection structure between the pair of the support arms at another end of the support and the front seat, the support can be outwardly rotated from the accommodation space via the pivotal connection structure being served as the pivot. The positioning structure provides a positioning effect for allowing the tool to be supported. Moreover, the support can be inwardly rotated into the accommodation space for making the support be stored. As such, a novel design for supporting and storing the tool is provided. Furthermore, the magnetic attraction structure may be additionally disposed on the support, so that when the tool is not in the operating state and the support is yet to be outwardly rotated, the tool can be directly attached to a magnetic conduction object, for example an iron-containing object, for being fastened. As such, the applicable field of the tool can be effectively expanded.

While the invention has been described by way of example and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A tool with a supporting function, including:
a main body and a support, wherein an accommodation space allowing said support to be accommodated is concavely formed on a bottom surface of said main body, two ends of said accommodation space are disposed with a front seat and a rear seat, a push bottom is sheathed with said rear seat, thus said push button is operated to slide on said rear seat between a first position and a second position, a locking mechanism used for locking or unlocking said support is disposed between said push button and one end of said support, a pivotal connection mechanism is disposed between a pair of support arms at another end of said support and said front seat, and said support is outwardly rotated from said accommodation space with said pivotal connection mechanism being served as a pivot for supporting said tool, and said support is inwardly rotated to be stored in said accommodation space.

2. The tool with the supporting function as claimed in claim 1, wherein said push button is radially protruded with a pair of tabs, said pair of said tabs are sheathed with a pair of slide slots correspondingly formed on said rear seat, so that said push bottom is operated to axially slide on said rear seat between said first position and said second position.

3. The tool with the supporting function as claimed in claim 1, wherein said pivotal connection mechanism includes a pair of pivotal shafts radially protruded from said front seat, and said pair of support arms are disposed with a pair of shaft holes pivotally connected to said pair of pivotal shafts.

4. The tool with the supporting function as claimed in claim 3, wherein each said shaft hole is formed as a C-shaped clip hole.

5. The tool with the supporting function as claimed in claim 3, wherein a positioning mechanism is formed at a connecting surface of a periphery of one said pivotal shaft, said positioning mechanism includes a positioning tenon arranged at one side of each said shaft hole, and a positioning slot arranged at one side of each said pivotal shaft, wherein, each said positioning tenon is displaced with a rotation movement of said pair of support arms to be buckled with one said positioning slot to form a positioned status.

6. The tool with the supporting function as claimed in claim 1, wherein said locking mechanism includes a convex sheet arranged at a front end of said push button, and a tongue sheet abutting against said convex sheet and arranged at a rear end of said support; wherein adjacent surfaces of said convex sheet and said tongue sheet are respectively and correspondingly formed with a buckle tenon and a buckle slot capable of being mutually buckled or released; when said buckle tenon is buckled with said buckle slot, said push button locks said support; when said buckle tenon is released from said buckle slot, said push button unlocks said support.

7. The tool with the supporting function as claimed in claim 1, wherein a penetrated hole is radially formed on said support, a pair of reverse hooks are disposed at at least one pair of opposite sides of said penetrated hole; said support further includes a magnetic attraction structure, said magnetic attraction structure includes a magnetic member defined as a strong magnet or a permanent magnet, and said magnetic member is buckled with said buckle hooks.

8. The tool with the supporting function as claimed in claim 7, wherein said magnetic attraction structure further includes an iron-containing protection cover least capable of covering and attracting said magnetic member, a circumference at a top end of said iron-containing protection cover has at least one pair of outwardly-bent abutting sheets, said at least one pair of said outwardly-bent abutting sheets abut against a circumference of an inner wall of said penetrated hole, so that said magnetic member and said iron-containing protection cover are prevented being from outwardly released from said penetrated hole.
